(19) United States
(12) Patent Application Publication
(10) Pub. No.: US 2008/0077592 A1
(43) Pub. Date: Mar. 27, 2008

(54) METHOD AND APPARATUS FOR DEVICE AUTHENTICATION

(76) Inventors: Shane Brodie, Dublin (IE); Joseph Mansfield, Leixlip (IE); David E. Bryne, Mullingear Co West Meath (IE); Michael Donohoe, Co Meath (IE); James N. Brennan, Dublin (IE)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/535,747

(22) Filed: Sep. 27, 2006

(51) Int. Cl. G06F 17/30; G06F 7/00

(52) U.S. Cl. 707/9

(57) ABSTRACT

In some embodiments, an apparatus and method includes storing in a database at least one device record of an associated pair of parameters received from at least one client device during a provisioning of the at least one client device, with the associated pair of parameters including a build predefined identifier unique to the at least client device and a public key generated by the at least one client device. In response to an access-seeking client device seeking access to a private computer network, an authentication server receives a requested predefined identifier from the access-seeking client device and uses the requested predefined identifier to search the at least one device record in the database for a matched device record.

### BACKGROUND

1. Technical Field

Embodiments of the present invention are related to the field of electronic devices, and in particular, to computer devices.

2. Description of Related Art

To maintain the security of a private computer network (e.g., enterprise network), a client computing device (“client device”) may be required to access the network by authenticating and establishing authorization to the network through an authentication server (“server”). Prior to granting the client device access to the network, the server may require the client device to supply authentication credentials to the server so that the server can be certain that the client device actually is the entity that the client device purports to be. The client device's authentication credentials indicate the client device's identity.

In some implementations, weak user based authentications may be used which do not inherently allow knowledge of the client device. In other implementations, remote authentication solutions may rely on software based solutions using Public Key Infrastructure (PKI) or third party tokens in order to uniquely identify the client device that is attempting to access the network. PKI provides the basis for managing various public keys that are used to provide network security through encryption and digital signatures. With PKI, a digital certificate is issued by a certification authority (CA) or other trusted authority.

### BRIEF DESCRIPTION OF THE DRAWINGS

FIG. 1 is a diagram of a device provisioning system for building a client device, according to some embodiments of the present invention.

FIG. 2 (divided over FIGS. 2A and 2B) is a flow chart of the building operation of the device provisioning system of FIG. 1, according to some embodiments of the present invention.

FIG. 3 is a diagram of a device authentication system to authenticate the client device, according to some embodiments of the present invention.

FIG. 4 (divided over FIGS. 4A and 4B) is a flow chart of the authentication operation of device authentication system of FIG. 1, according to some embodiments of the present invention.

FIG. 5 is a diagram of trusted platform components of the client device, which are used by the device provisioning and device authentication systems, according to some embodiments of the present invention.

FIG. 6 is a diagram of a device record, according to some embodiments of the present invention.

### DETAILED DESCRIPTION OF ILLUSTRATIVE EMBODIMENTS

In the following description, for purposes of explanation, numerous details are set forth in order to provide a thorough understanding of the disclosed embodiments of the present invention. However, it will be apparent to one skilled in the art that these specific details are not required in order to practice the disclosed embodiments of the present invention. In other instances, well-known electrical structures and circuits are shown in block diagram form in order not to obscure the disclosed embodiments of the present invention. The term “coupled” shall encompass a direct connection, an indirect connection or an indirect communication.

In the following description, terminology is used to discuss certain features of various embodiments of the present invention. A “client device” or “server” includes hardware and/or software that process information. “Software” includes code that, when executed, performs a certain function. “Information” is defined as one or more bits of data, address, and/or control. A “link” is defined as one or more information-carrying mediums (e.g., electrical wire, optical fiber, cable, bus, or wireless signaling technology).

A “cryptographic operation” is an operation performed for additional security on information. These operations may include encryption, decryption, hash computations, and the like. In certain cases, the cryptographic operation uses a key, which is a series of bits. For asymmetric key cryptography (“public key cryptography”), a particular entity (e.g. client device or server) is associated with unique “key pair” or public-private “key pair” or “asymmetric key pair” that includes a “public key” and a “private key”. In general, data encrypted with the public key may be decrypted only with the associated private key of the key pair and data encrypted by the private key may only be decrypted by the associated public key.

A “digital signature” is a data item that vouches for the origin and integrity of a message. The originator generates a hash of the message, uses its private key (signing key) to encrypt the hash, and then sends the message and the encrypted hash to a receipent. The encrypted hash is referred as a digital signature or signed hash. The recipient uses a public key of the originator (verification key) to verify the origin of the message and that it has not been tampered with during transmit. A “hash” may be created by a one-way hash operation, which is a one-way conversion of information to a fixed-length.

A client computing device (“client device”), according to some embodiments of the present invention, may be built so that it may be securely authenticated for access to a private computer network without the need for tokens or digital certificates of third parties. The client device has a unique, predefined identification (ID) identifying the client device. Additionally, during provisioning of the client device, the client device generates a key pair of a public and private key. Consequently, each client device may be characterized as having an “associated pair of parameters” including the predefined ID and the public key, with the both parameters being unique to the client device.

During the provisioning of a client device, the predefined ID (referred to as the “build predefined ID”) is obtained by the private computer network from the client device in a manner that the network may be assured that it originated with the client device. For example, in some embodiments, at least the build predefined ID may be obtained by the network during the provisioning of the client device over a secure connection with the client device. Additionally, in some embodiments, the client device, prior to any downloading of software in the provisioning, may use a trusted boot process implemented by a trusted security module. In some embodiments, the client device may protect at least its private key using the trusted security module.

The public key also is obtained from the client device by the private computer network during the provisioning, so that the network may be assured that the public key originated from the client device. Hence, by obtaining both parameters of the associated pair of parameters during provisioning, the network may be assured that they are associated with each other and with the client device, allowing the network to build a reliable database.

The network may store the associated pair of parameters for each of the client devices in a “device record” in a database, with the pair of parameters being linked to each other in the device record and the device record being searchable by the build predefined ID. Consequently, for a given client device, the build predefined ID may be used to locate the associated public key in the database.

Thereafter, the associated pair of parameters is used in an authentication process for authenticating the client device when the client device (now referred to as an “access-seeking client device”) requests access to the private computer network. In some embodiments, in response to an access-seeking client device seeking access to the private computer network (“access request”), an authentication server may challenge the access-seeking client device for the predefined ID (now referred to as the “requested predefined ID”). In other embodiments, the requested predefined ID may be included in the access request of the client device, eliminating the need for a separate challenge by the authentication server. Upon obtaining the requested predefined ID, the private network may use the requested predefined identifier to search the device records in the database for a “matched device record”. A matched device record may be found when a device record is found with a build predefined ID that matches the requested predefined ID of the access-seeking device client.

In the event the matched record is not found, the authentication server may deny access to the access-seeking client device at this point in the authentication process. In the event of the matched record is found, the authentication server may proceed with additional authenticating operations for the access-seeking client device using the looked-up public key from the matched record. For example, the authentication server may present the access-seeking client device with a challenge encrypted by the public key obtained from the matched device record. The access-seeking client device may decrypt the encrypted challenge using its associated private key to generate a decrypted challenge and then may send the decrypted challenge to the authentication server. The authentication server then may compare the received decrypted challenge and the original challenge, with a match being a prerequisite to the granting the access request. The challenge authentication process, which may include a two-way authentication process in some embodiments, is described in more detail below.

In some embodiments, prior to granting access to the client device, the authentication server may validate that the client device has not been tampered with. This validation may be accomplished in a number of ways. For example, the client device, prior to seeking access to the private computer network, may use a trusted boot process implemented by the trusted security module. The authentication server may check on the results of this trusted boot process to validate that the client device has not been tampered with. In other embodiments, the authentication server may initiate the trusted boot process during the authentication process and then check its results. In other embodiments, a build signing of the code objects of the client device may be undertaken.

In some embodiments, the database, which may contain a plurality of device records, may be in a separate device key register coupled to the authentication server. In other embodiments, the database may be included in the authentication server. In some embodiments, the associated pair of parameters, including the build predefined ID and the public key, does not need to be kept secret. In other embodiments, some additional security may be added by limiting of distribution of the public key to the components of the private computer network and the client device.

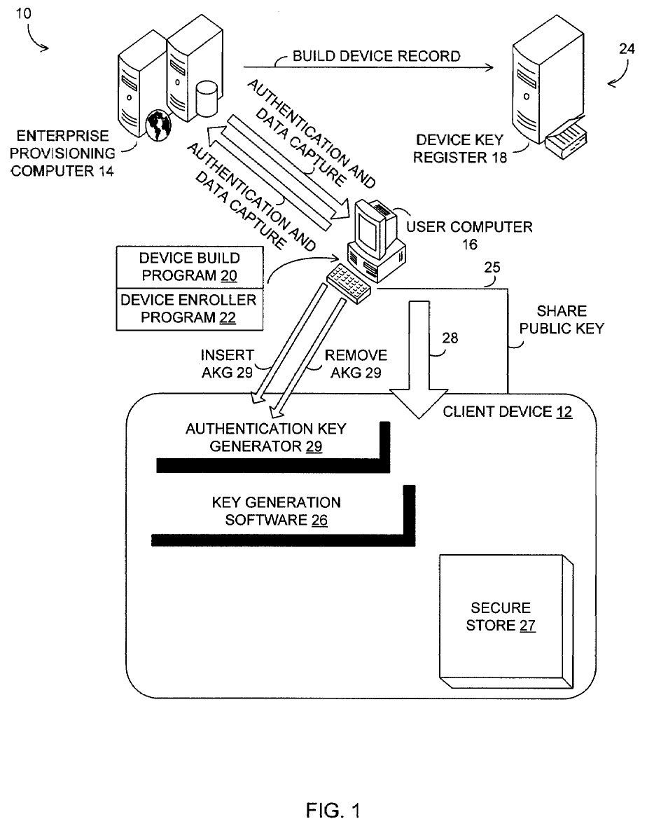

With reference to FIG. 1, there is illustrated a device provisioning system 10, according to some embodiments of the present invention, for building or provisioning a client device 12. In some embodiments, the device provisioning system 10 may include a device provisioning computer 14, a user computer 16, and a device key register (DKR) 18, which communicate with each other during various stages of a build for the client device 12. In some embodiments, the user computer 16 may execute two software programs, a device build program 20 and a device enroller program 22.

Although the client device 12 may be discussed or illustrated herein as a mobile device, such as a hand-held device or a notebook device, the client device 12 may include any computing device, such as a desktop computer, a workstation, a server, or any other computing device, needing authentication to be provided access to a private computer network (“network”) 24. The DKR 18 may be part of the network 24 and, for example, may be placed behind a firewall for the network 24. In some embodiments, the network 24 may be an enterprise network for a corporation or an organization which needs to control access to its network or services. Examples of an enterprise network may include a service provider or a bank. A “user” may be any entity or person who will use the client device 12 to obtain access to the resources of the network 24.

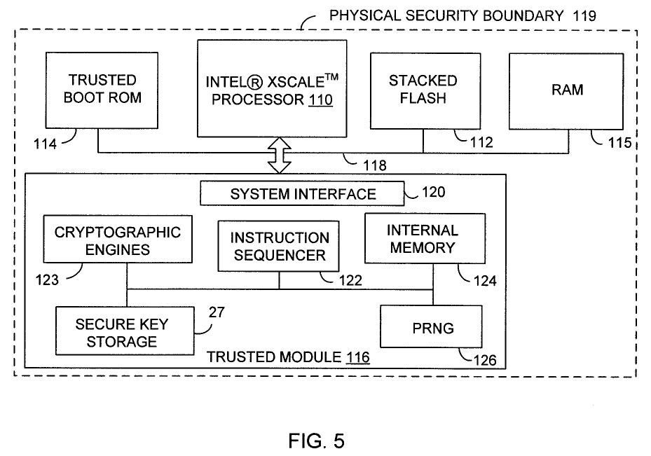

In some embodiments, during the build of the client device 12, the user computer 16 may be tethered to the client device 12 during provisioning, as illustrated by a tethered connection 25, to allow secure communications during the build of the client device 12. In other embodiments, different security mechanisms may be used for secure communications between the user computer 16 and the client device 12, such the software provided by the user computer 16 being signed with digital signatures. An illustrative example of the pre-existing components of the client device 12 will be described hereinafter (see FIG. 5), but for the purpose of explaining the device provisioning system 10, some of the components of the client device 12 are shown in FIG. 1. These illustrative components include pre-existing key generation software 26 and a secure key store 27.

In some embodiments, the device build program 20, when executed by the user computer 16, may download provisioning software 28 to the client device 12, such as antivirus software and management software including software needed for implementing an authentication protocol to be described hereinafter. In general, the client device 12 may be managed by the network 24 once connected. The device build program 20 may be characterized as placing a “software build” onto the client device 12. In some embodiments, a secure boot process may be undertaken prior to downloading the build software to the client device 12 to insure that the preexisting code objects on the client device have not been modified, as will be described hereinafter in the discussion of FIG. 5.

The device enroller program 22, when executed by the user computer 16, may control enrollment of the client device 12 with the network 24. The device enroller program 22 also may download an Authentication Key Generator (AKG) 29 to the client device 12. The AKG 29 may be characterized as a code object that is put onto the client device 12 as part of the build by the device enroller program 22 and, once placed in the client device 12, may be used to generate the asymmetric key pair including the public key and private key on the client device 12. In other words, the AKG 29 may contain the algorithms for generating the key pair. The client device 12 may come with pre-existing key generating software 26 which includes an Application Interface (API) to receive the AKG 29. The instance of the AKG 29 may be destroyed on the client device 12 when enrollment is complete. In some embodiments, the keys generated may be Rivest-Shamir-Adleman (RSA) paired keys, including a public and a private key. In other embodiments, public-private key pairs may be generated by different algorithms.

As previously mentioned, the client device 12 has a unique, predefined ID which may be used to uniquely identify the client device 12 to the network 24. For example, the predefined ID may be Universal Unique Identifier (UUID). In some embodiments, an operating system for the client device 12 may include a way of generating a UUID. This predefined ID example is sometimes referred to as a Globally Unique Identifier (GUID). In some embodiments, the UUID may be stored a system management Basic Input/Output System (BIOS) table, which may be protected against alteration.

In some embodiments, where the client device 12 is a hand-held cellular phone, the predefined ID may be an international mobile equipment identifier (IMEI) or equipment serial number (ESN). In some embodiments, this predefined ID may be in a flash memory of the cellular phone. In other embodiments, this predefined ID may be implanted during manufacture in the memory of the client device 12 and may not correlate with any known ID system.

Prior to the device provisioning shown in FIG. 1, in some embodiments, the client device 12 may start the process already provisioned with a base operating system (OS). In other words, in some embodiments, the client device 12 may already be a functional device, but one that is not allowed access to the private computer network 24 until the device provisioning system 10 has configured (built it) to include security and management software. In other embodiments, the device provisioning system 10 may provide more functionality to the client device 12, such as the OS for a “bare-metal” client device 12. In some embodiments, this provisioning of the client device 12 may be undertaken in an Information Technology (IT) shop for the network 24.

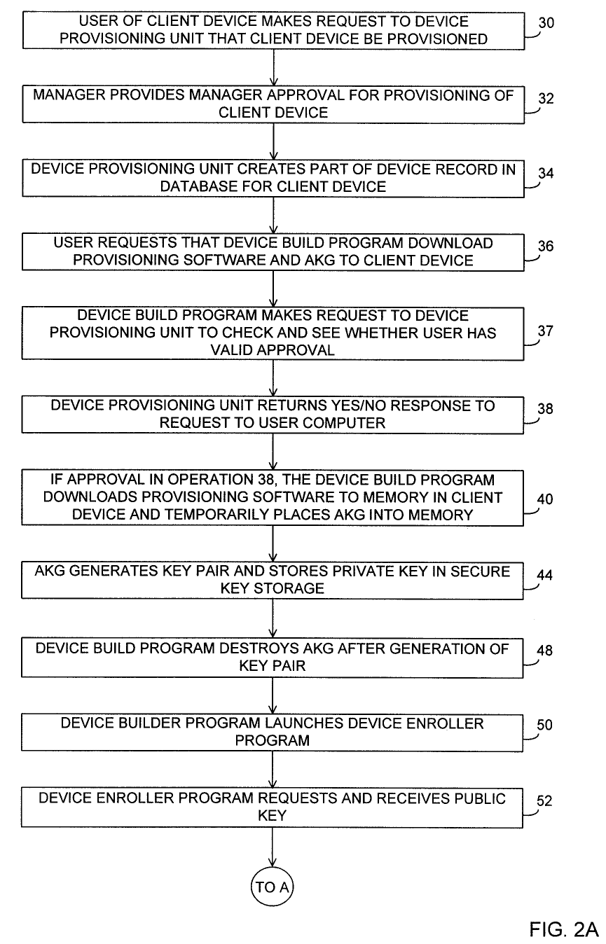

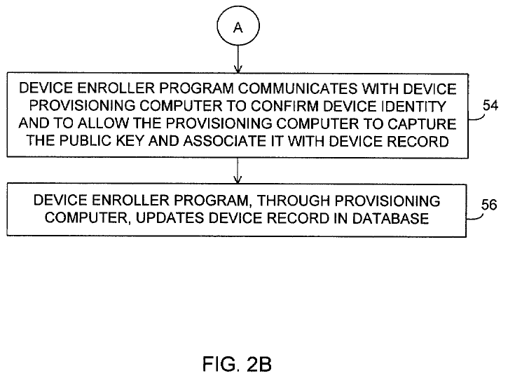

Referring to FIG. 1 and a flow chart of FIG. 2 (divided over FIGS. 2A and 2B), the operation of the device provisioning system 10, according to some embodiments of the present invention, will now be described. In an operation 30 of FIG. 2, a user of the client device 12 may make a request to the device provisioning computer 14 that the client device 12 be provisioned with the provisioning software 28 and AKG 29. In some embodiments, the device provisioning system 10 may contain or have access to directory services. In this implementation, it is assumed that the user is listed as an authorized user in such directory services. In some embodiments, the user computer 16 may be an approved device and part of the network 24, as recorded in the device provisioning computer 14.

In an operation 32 of FIG. 2, in response to the request by the user, a manager with authority for the network 24 may provide a manager approval for the provisioning of the client device 12. In an operation 34 of FIG. 2, the device provisioning computer 14 may create at least a portion or framework of a device record in a database in the DKR 18 for the client device 12. In some embodiments, the predefined ID may be obtained by the device provisioning computer 14 from the client device 12 and placed by the device provisioning computer 14 into the device record in the database at this time. As previously described, in some embodiments, the database containing the device record may be contained in the DKR 18. This database may contain a number of the device records for a number of client devices 12, which are searchable by the build predefined ID. However, the database may be located in network components, including an authentication server to be described hereinafter.

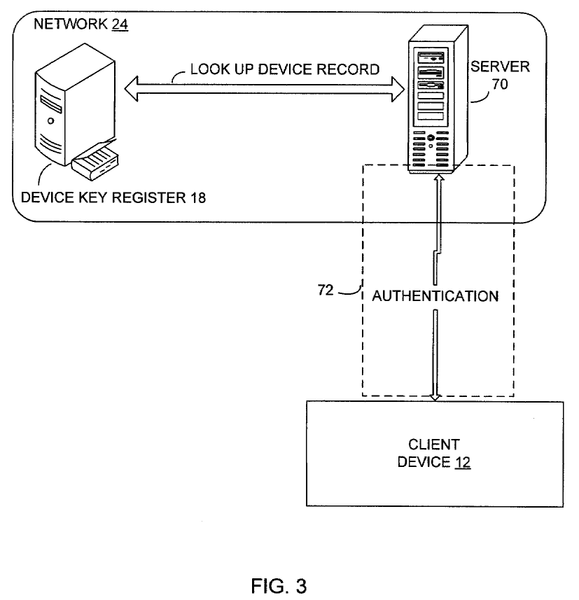

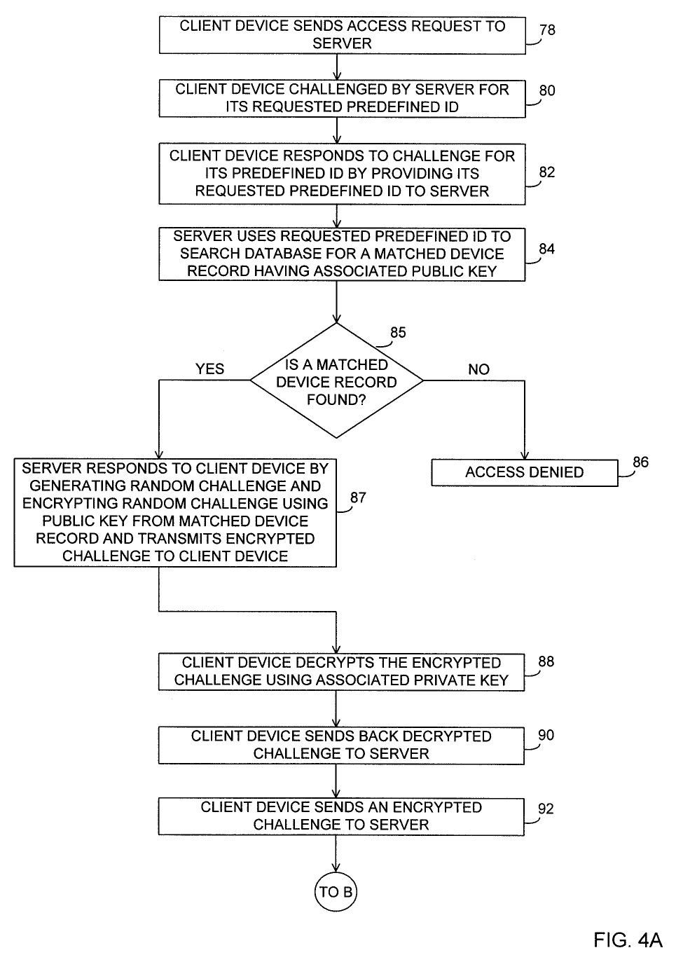

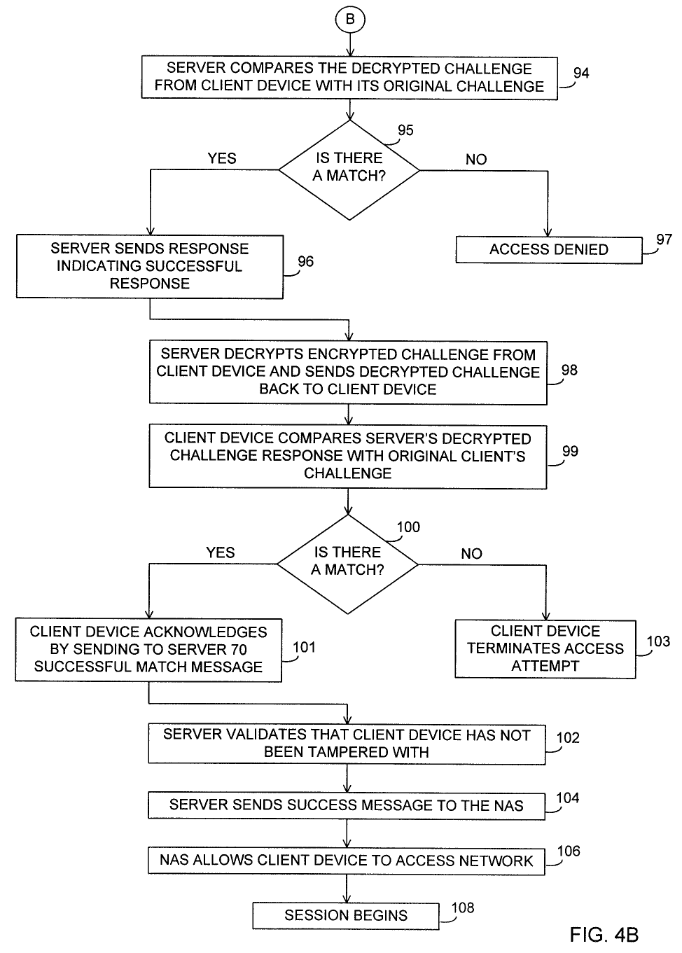

In an operation 36 of FIG. 2, the user may request that the device build program 20 download the provisioning software 28 and the AKG 29 to the client device 12. In an operation 37, upon the user requesting that the user computer 16 download this software build to the client device 12, the device build program 20 may make a request to the device provisioning computer 14 to check and see whether the user has valid approval. In an operation 38, the device provisioning computer 14 may return a yes/no response to this request to the user computer 16. In the operation 38, server authentication using public key techniques may be undertaken at this point. Server authentication also is described with respect to FIGS. 3 and 4 when the client device 12 requests access to the network 24; hence, more detail on server authentication using public key techniques is provided hereinafter.

If approval is obtained in operation 38, then in an operation 40 of FIG. 2, the device build program 20 may download the provisioning software 28 to memory (not shown) in the client device 12 and may temporarily place the AKG 29 into memory of the client device 12 (not shown). The provisioning software 28 may include build management software, as previously described. In an operation 44 of FIG. 2, the AKG 29 may generate in an asymmetric key generation process an associated key pair, including a private key and a public key, and via the API of the key generating software 26, store the private key in a secure key storage 27. Storage of the private key, e.g., between boots or long sleeps during which memory is cleared, will be described with respect to FIG. 5. In an operation 48 of FIG. 2, the device build program 20 may destroy the AKG 29 after the generation of the key pair.

In some embodiments, in an operation 50 of FIG. 2, the device builder program 20 may launch the device enroller program 22. In other embodiments, the programs 20 and 22 may be one program. In an operation 52 of FIG. 2, the device enroller program 22 may request and receive via the tethered connection 25 the public key, while the client device 12 retains and keeps secret it private key. More specifically, the AKG 29 may provide the public key in a secure communications over the tethered connection 25 during the provisioning of the client device 12.

In an operation 54 of FIG. 2, the device enroller program 22 may communicate with the device provisioning computer 14 so as to confirm the device identity and to allow the provisioning computer 14 to capture the public key and associate it with the device record and the user. In an operation 56 of FIG. 2, the device enroller program 22, through the provisioning computer 14, may update the device record in the database of the DKR 18 with the public key. The device record in the DKR 18 may create a data record which identifies the paired parameters of the predefined ID and public key for each client device 12.

In some embodiments, a secure connection between the device enroller program 22 and the client device 12 may be achieved without the tethered connection 25. In these embodiments, a secure connection may be achieved by the downloaded or pre-loaded provisioning software 28 and the AKG 29 being signed with a digital signature of the device enroller so that they only may be run if it is trusted by the operating system of the client device 12. Hence, if any change is attempted to the provisioning software 28, for example, in an attempt to alter the authentication process, then the components of provisioning software 28 will not execute on the client device.

In some embodiments, by tethering to the user computer 16 via the tethered connection 25, a secure communications tunnel is established to the network 24. As will be described hereinafter, in some embodiments, a trusted boot process may occur prior to the build (and later prior to authentication) to check the client device 12 as being “good”.

Once the client device 12 is built, it is known to the network 24. The build may be trusted and may be resistant to tampering by either using a trusted boot process (to be described hereinafter with respect to FIG. 5) or a signing with a digital signature of the build by the client device 12 with the device's generated private key. With one of these protections in place, the client device 12 may be allowed access to the network 24 as a trusted device. Once the client device 12 has been built and enrolled in the network 24, then the associated pair of parameters, as described above, may be used to authenticate the client device 12 to the network 24, as will be described with respect to FIGS. 3 and 4.

With reference to FIG. 3, there is illustrated the private computer network 24, with the client device 12 seeking access to the network 24 via communications with an authentication server 70 over a public network 72, such as a wireless public network. The authentication server 70 is coupled to the DKR 18 with secure lock down access. An authentication and authorization process, according to some embodiments of the present invention, will be described with respect to a wireless client device 12; however, as explained earlier, the client device 12 may be a wired client device. In this illustrative authentication process, the wireless client device 12 and the wireless network infrastructure may employ a network access protocol, such as the Electrical and Electronics Engineers (IEEE) 802.1X standard (approved Jun. 14, 2001, Supplement to IEEE Standard 802.1D-1998), which is based on the Extensible Authentication Protocol (EAP). This protocol provides an authentication framework that supports a variety of methods for authenticating and authorizing network access for the wireless client devices. Although the process is discussed using EAP, other network access protocols may be used.

The client device 12 retains and has exclusive access to the private key. The DKR 18 may contain the paired parameters of the predefined ID and the public key, as a result of the build and enrollment processes described in FIGS. 1 and 2. In some embodiments, the authentication server 70 may be an Authentication, Authorization, and Accounting (AAA) server. One example of an AAA server may be a Remote Authentication Dial-In User Service (RADIUS) server. Guidelines for the use of RADIUS in IEEE 802.1X may be found in Annex D of the IEEE Standard 802.1X-2001 document.

The authentication server 70 may be configured to take advantage of the predefined ID and the public key acquired from the client device 12 during the provisioning of the client device 12, as will be described hereinafter. Once authentication is achieved access may be allowed to the network 24 by the device 12.

The client device 12 may identify itself using the requested predefined ID, which is used by the authentication server 70 to look up the shared public key for that particular client device 12. The authentication server 70 may use the looked-up public key to challenge the client device 12 to provide a response that requires the private key of the client device 12 to be used. A proper response showing that the client device 12 has the associated private key may establish device authentication.

Referring to FIG. 3 and a flow chart of FIG. 4 (divided over FIGS. 4A and 4B), the authentication and authorization process, according to some embodiments of the present invention, will now be described in more detail. In an operation 78, a given client device 12 (referred to as an “access-seeking client device”) may send an access request to the authentication server 70, requesting access to the network 24.

In an operation 80, in response to the access request, the client device 12 may be challenged by the authentication server 70 for its predefined ID (now referred to as the “requested predefined ID”). The predefined ID is the unique identifier that the network 24 knows from the build process of the client device 12 described with respect to FIGS. 1 and 2. In some wireless embodiments, operation 80 may be achieved by the authentication server 70 sending an EAP-request/identity message, where the client device 12 is a wireless client device 12. In some embodiments, the operations 78 and 80 may be merged into one operation by the access request from the client device 12 including the requested predefined ID.

In an operation 82, the client device responds to the challenge for its predefined ID by providing its requested predefined ID to the authentication server 70. In some wireless embodiments, operation 82 may include the client device 12 responding with an EAP-response/identity message that contains the identity of the client device 12 in the form of providing the requested predefined ID.

In an operation 84, the authentication server 70 may use the requested predefined ID received from the client device 12 to look up the device record for the client device 12 in the database of the DKR 18 so as to obtain the associated public key, with such records being accessible by using the predefined ID. This look-up involves the authentication server 70 searching the device records for one having a build predefined ID that matches the requested predefined ID, referred to as a “matched device record”. In an operation 85, if no matched device record is found, then access, then the authentication procedure proceeds to operation 86, where access is denied to the access-seeking client device 12. If a matched device record is found, the authentication procedure may proceed to an operation 87.

In the operation 87, the authentication server 70 may respond to the client device 12 transmission of the predefined ID by generating a random challenge and encrypting the random challenge using the public key from the matched device record and then transmitting the encrypted challenge to the client device 12. In some wireless embodiments, operation 87 may include the authentication server 70 sending an EAP-request/EAP-hardware encrypted challenge message that contains a random challenge string encrypted with the looked-up public key.

In an operation 88, the client device 12 may decrypt the encrypted challenge using the associated private key. In an operation 90, the client device 12 may send back the decrypted challenge to the authentication server 70. In some wireless embodiments, the operation 90 may include the client device 12 responding with an EAP-response/EAP-hardware response message that contains a response in the form of the decrypted challenge string. In some embodiments, the response may be re-encrypted using the private key. As described hereinafter in operation 92, in some embodiments, where two-way authentication is desired, this response from the client device 12 to the network 24 may also include an encrypted challenge sent by the client device 12 to the authentication server 70.

In an operation 92, as previously mentioned, the response by the client device 12 in operation 90 also may include a encrypted challenge sent by the client device 12 to the authentication server 70, which may be a random string encrypted by the client device 12 with the public key of the authentication server 70. This challenge is for authentication of the authentication server 70, which may result in two-way authentication. Alternatively, this added response to the challenge by the authentication server 70 may occur separately from the response in operation 90.

In an operation 94, the authentication server 70, upon receiving the decrypted challenge from the client device 12, may compare the response (decrypted challenge) with its original challenge that it previously sent in the operation 87. In an operation 95, the authentication procedure determines if there is a match. If there is a match, then in an operation 96, the network 24 may send a response indicating a successful response. In some wireless embodiments, in the operation 96 the authentication server 70 may send an EAP-request/EAP-hardware success message, which indicates that the response of the client device 12 was correct. If there is no match, then in an operation 97 access may be denied to the access-seeking client device 12.

Assuming that the operation 92 added an encrypted challenge for the authentication server 70 to its response in operation 90 (two way authentication), in operation 98 the authentication server 70 may decrypt the encrypted challenge using its private key and then send in the decrypted challenge to the client device 12. In some embodiments, this challenge response of the authentication server 70 may include the successful response message of operation 96. In other words, a single transmission from the authentication server 70 may include both (1) the success message indicating that the client device 12 had successfully met the challenge of the authentication server 70 and (2) the challenge response (decrypted challenge) to the client's challenge of the authentication server 70. In some wireless embodiments, the challenge response provided by the authentication server 70 in the operation 98 may contain the response of the authentication server 70 to the client challenge string, which is the decrypted EAP-hardware response message.

In an operation 99, upon the client device 12 receiving the challenge response (decrypted challenge) from the authentication server 70, the client device 12 may compare the server's decrypted challenge response with the original client's challenge. In an operation 100, the procedure determines if there is a match. If there is a match, then the authentication procedure may proceed to an operation 101, where the client device 12 may acknowledge by sending to the authentication server 70 a successful match message. In some wireless embodiment, in the operation 101, the authentication server 24 may respond with an EAP-response/EAP-hardware acknowledgement (ACK) message, indicating that the authentication server response was correct. Thereafter, the authentication procedure may proceed to an operation 102. If there is no match, then at an operation 103, the client device 12 terminates its attempt to obtain access.

In the operation 102, the authentication server 70 may validate that the client device 12 has not been tampered with. In some embodiments, this may be achieved by checking the trust security module (FIG. 5) to see if the trusted boot process has been able to validate the code objects of the client device 12. As previously mentioned, the trusted boot process, which may be implemented by the trusted security module, may have been undertaken at least prior to starting the authentication process when the client device 12 was turned on. In other embodiments, to validate that the client device 12 has not been tampered with, a build signing may be undertaken. A build signing may be achieved by signing the code of the client device 12 so that there is a chain of trust prior to execution.

In the operation 104, the authentication server 70 may send an EAP-Success message to the NAS (Network Access Service), which is part of the network 24, but is not shown. In response, in the operation 106, the NAS may allow the client device 12 to have access to the network 24. In an operation 108, a session may be started with the user of the client device 12.

As previously mentioned, in some embodiments, the associated pair of the predefined ID and the public key does not need to be kept confidential or secret. In other embodiments, the public key may be kept secret and shared only with the client device generating it and the private computer network needing it for authentication. This may provide a little additional security. For additional security, the paired parameters (the public key and predefined ID) may be transferred in a secure manner from the client device 12 to the database (e.g., tethered connection) and the database may maintained in a secure storage location in the private computer network (e.g., the DKR 18 may be maintained in a secure manner). Likewise, in some embodiments, the public key (and therefore its association with the predefined ID and the client device) may be maintained in a secure location in the client device 12.

Referring to FIG. 5, an illustrative example of the client device 12 is shown. However, the client device 12 may take many different forms and FIG. 5 is merely illustrative of one example. The client device 12 illustrated in FIG. 5 may be a cellular phone or a Personal Digital Assistant (PDA); however, as previously described, the client device 12 may be any other computing device. Additionally, the client device 12 is shown with illustrative hardware and software components that may be included in the client device 12 at time of manufacture, prior to the provisioning process of FIGS. 1 and 2. In the illustrative example of FIG. 5, the client device 12 is an Intel® Wireless Trusted Platform manufactured by Intel Corporation (product also referred to as Bulverde). In general, this technology may provide services, such as trusted boot, secure storage of private information and cryptographic keys, and support for security protocols.

The client device 12 may include a processor 110, such as the Xscale™ processor manufactured by Intel (e.g., Intel's PXA27x family of processors); a non-volatile memory 112, such as stacked flash memory; a trusted boot Read Only Memory (ROM) 114; a Random Access Memory (RAM) 115, such as static RAM (SRAM); and

a Trusted Security Module (TSM) 116, all coupled together by a bus 118. In some embodiments, the non-volatile memory 112 may be divided into controlled/trusted and non-trusted blocks. In some embodiments, the RAM 115 may be partitioned into secure and non-secure partitions, where the processor 110 cannot read/write to secure RAM portion and the TSM 116 cannot read/write outside of secure RAM portion. The components shown in FIG. 5 may be surrounded by a physical security boundary 119, with the physical security boundary 119 protecting security components from being replaced or tampered with. In some embodiments, the AKG 29 may be downloaded to the RAM 115. However, in other embodiments, the AKG 29 may be downloaded to non-volatile memory 112.

In addition to an operating system, security application software may be provided and stored in the non-volatile memory 112 and included on the client device 12 prior to the above described provisioning. The security software may provide access to the TSM 116 through cryptographic APIs. In particular, the security software may include the key generation software 26 previously shown in FIG. 1 which provides the API for the AKG 29 of FIG. 1. As previously mentioned, this technology, referred to as the Intel® Wireless Trusted Platform, is commercially available from Intel Corporation.

The TSM 116 may also be referred to as a hardware cryptographic unit. In general, the TSM 116 may provide a trusted processing environment which performs cryptographic operations and protects cryptographic keys and related data. In some embodiments, the TSM 116 may include a system interface 120 coupled to the bus 118 and an instruction sequencer 122 coupled to the system interface 120. The instruction sequencer 122 may be coupled to the cryptographic engines 123, an internal memory 125, a pseudorandom number generator (PRNG) 126, and the secure key store 27 previously shown in FIG. 1.

The cryptographic engines 123 may include a number of hashing engines for integrity checks, encryption engines for data protection, and an exponentiation unit for key distribution and digital signatures. In some embodiments, these engines may be implemented by hard-wired logic. The PRNG 126 may be used to generate the random numbers described in the authentication process previously described with respect to FIGS. 3 and 4.

The internal memory 125 may provide storage for intermediate results and may include general purpose registers. The TSM 116 may be programmed with a random master key, which may be used to generate subkeys for encrypting user keys, such as the private key of the private-public key pair, before they are placed in non-volatile memory 112. In this embodiment, the TSM 116 does not contain non-volatile memory; hence, user keys need to be encrypted and stored in the non-volatile memory 112 between reboots and over sleeps that clear memory. Decrypted user keys (e.g., private key) are only exposed while in the TSM 116. Additionally, the private key generated by the AKG 29 and temporarily stored in the secure key store 27, may be encrypted with a subkey and move to the non-volatile memory 112. In some embodiments, the public key does not need to be encrypted with the subkey. In other embodiments, where distribution of the public key is to be limited, the public key also may be encrypted.

The sequencer 122 may run security operations to completion. Requests for security services come from the security software, which may translate requests for services into primitive instructions. Primitive instructions for the TSM 116 may include, for example, initiation, symmetric encryption, asymmetric encryption, random numbers, key management, and key exchange. The sequencer 122 may generate control signals to control key usage and data movement inside of the TSM 116 and to cause the engines to perform the basic cryptographic operations requested by the primitive instructions.

In some embodiments, to confirm that the client device 12 has not been tampered with, and therefore can prove itself to be the same client device that was built with the predefined ID, the trusted boot process may be implemented by the TSM 116. In the trusted boot process, the TSM 116 may validate that code objects, including the boot code from the trusted boot ROM 114, have not been tampered with. The TSM 116, at power up or OS request, may be used to validate the code objects. In general, the trusted boot process may validate the software/firmware of the client device 12 by using signature hashes and may detect accidental or malicious modifications to code.

As one example of this trusted boot process, the manufacturers of the code objects may calculate hashes for the code objects, and use the manufacturers' private keys to sign the hashes, with each manufacturer/vendor having a unique public-private key pair. The TSM 116 may load a given manufacturer's signed hash, manufacturer's public key, and the code object to be tested (measured). Then the TSM 116 may calculate the hash from the code object (calculated hash), unsign (decrypt) the manufacturer's hash using the manufacturer's public key to create an un-signed hash, and then compare the calculated hash with the unsigned hash. If the values match, then the code object has been validated. The TSM 116 may start with validating the boot code from the trusted boot ROM 114, and then proceed with validating other code objects of the client device 12. In some embodiments, the trusted boot process may follow the Trusted Computing Platform Alliance (TCPA) standard entitled “The TCPA Main Specification”, version 1.1a, Nov. 12, 2001, which can currently be found at www-trustedcomputing-org (to avoid inadvertent hyperlinks the periods in the preceding URL have been replaced by dashes).

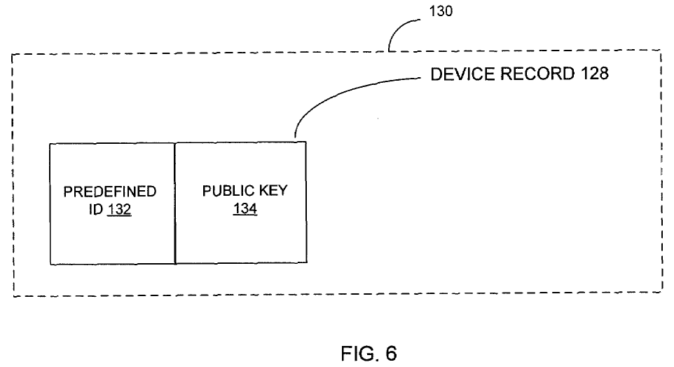

Referring to FIG. 6, there is illustrated a device record 128 in a database 130. The database 130 may include a plurality of the device records 128, with each device record 128 corresponding to a unique client device. In some embodiments, the database 130 may be located in the DKR 18 of FIGS. 1 and 3. The device record 128 may contain a build predefined ID 132 of a given client device, a public key 134 for the given client device. This device record 128 may be accessed in the database 130 by the build predefined ID 132. Hence, when the authentication server 70 of FIG. 3 receives the requested predefined ID, it may access this device record 128 by its build predefined ID and compare it with the requested predefined ID. A match means that the other data in this data record 130 have been successfully “looked up”. A plurality of device records 128 may be searched in this manner to find a match. In some embodiments, the DKR 18 of FIGS. 1 and 3 may have its own processor for undertaking this search. In other embodiments, a processor of the authentication server 70 of FIG. 3 may be used to undertake the search. In either case, the authentication server 70 of FIG. 3 initiates the search.

Device-base authentication, according to some embodiments of the present invention, may be independent of the operating system (OS) and the transport protocol. In some embodiments, the device-based authentication may provide an easy to implement one-click logon solution, and may provide the private computer network with more control and security and reduced cost. The solution described herein may provide private computer networks with a seamless basis by which they may allow their client devices to securely connect back to the network over any transport that supports the appropriate protocol.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

1. A method, comprising:
storing in a database at least one device record of an associated pair of parameters received from at least one client device during a provisioning of the at least one client device, with the associated pair of parameters including a build predefined identifier unique to the at least client device and a public key generated by the at least one client device;
in response to an access-seeking client device seeking access to a private computer network, receiving with an authentication server a requested predefined identifier from the access-seeking client device; and
using the requested predefined identifier to search the database for a matched device record.

2. The method according to claim 1, further comprising:
receiving with the authentication server an access request from the access-seeking client device seeking the access to the private computer network; and
in response to the access request, challenging with the authentication server the client device to provide the requested predefined identifier.

3. The method according to claim 1, wherein the storing in the database of the at least one device record of an associated pair of parameters includes forming the at least one device record to have the associated pair of parameters linked to each other and searchable by the build predefined identifier.

4. The method according to claim 3, wherein the using of the requested predefined identifier to search at least the one device record in the database for the matched device record includes comparing the requested predefined identifier with at least the build predefined identifier of the at least one device record.

5. The method according to claim 4, further comprising:
if the matched device record is found, authenticating with the authentication server the access-seeking client device using the public key of the matched device record.

6. The method according to claim 5, further comprising:
if the matched device record is not found, denying access with the authentication server to the access-seeking client device.

7. The method according to claim 5, wherein the authenticating with the authentication server of the access-seeking client device includes:
presenting by the authentication server of an encrypted challenge to the access-seeking client device, with the encrypted challenge being a challenge encrypted by the public key;
receiving by the authentication server of a decrypted response from the access-seeking client device in response the encrypted challenge, with the decrypted response being the encrypted challenge decrypted by the access-requesting client using a private key associated with the public key; and
comparing by the authentication server of the decrypted response and the challenge, with a match being a prerequisite to granting the access request.

8. The method according to claim 7, further comprising:
validating with the authentication server that the client device has not been tampered.

9. The method according to claim 1, wherein the storing in the database of the at least one device record of the associated pair of parameters includes receiving the associated pair of parameters from the at least one client device over a secure connection during the provisioning of the at least one client device.

10. The method according to claim 1, wherein the build predefined identifier is a selected one of a Universal Unique Identifier (UUID), an international mobile equipment identifier (IMEI), an equipment serial number (ESN), and a number implanted in the client device during manufacture of the client device.

11. The method according to claim 1, wherein
the storing in the database of the at least one device record of the associated pair of parameters includes placing the database in a device key register and including in the database a plurality of device records of associated pairs of parameters received from a plurality of client devices during the provisioning of the plurality of client devices; and
the using of the requested predefined identifier to search at least the one device record in the database for the matched device record includes comparing the requested predefined identifier with a plurality of build predefined identifiers of the plurality of device records.

12. The method according to claim 1, further comprising:
downloading a key generator to the at least one client device during the provisioning of the at least one client device;
using in the at least one client device the key generator to generate an asymmetric key pair including the public key and a private key: and
using a trusted security module (TSM) to encrypt at least the private key for storage in a memory.

13. The method according to claim 1, further comprising:
applying, during at least booting of the at least one client device, a trusted boot process to at least one code object on the at least one client device to verify that the at least one code object has not been modified.

14. A method, comprising:
providing a client device with a predefined identifier unique to the client device;
provisioning the client device with an authentication key generator (AKG);
using the AKG to generate an asymmetric key pair including a private and a public key; and
seeking access with the client device to a private computer network by providing to an authentication server the predefined identifier.

15. The method according to claim 14, wherein the seeking of the access to the private computer network includes:
sending with the client device an access request to the authentication server;
receiving with the client device a challenge from the authentication server to provide the predefined identifier, with the challenge being triggered by the sending of the access request; and
in response to the challenge from the authentication server, providing with the client device the predefined identifier to the authentication server.

16. The method according to claim 14, further comprising:
receiving with the client device an encrypted challenge from the authentication server encrypted using the public key, with the encrypted challenge being triggered by a successful providing of the predefined identifier to the authentication server;
decrypting by the client device of the encrypted challenge to generate a decrypted challenge; and
sending by the client device of the decrypted challenge to the authentication server as a prerequisite to obtaining the access to the private computer network.

17. The method according to claim 14, further comprising:
removing the AKG from the client device after the generating of the asymmetric key pair.

18. The method according to claim 14, further comprising:
applying a trusted boot process to at least one code object on the client device to verify that the at least one code object has not been modified prior to the provisioning of the client device and prior to the seeking access with the client device to the private computer network.

19. A system, comprising:
a processor;
a trusted boot read only memory (ROM), a non-volatile memory, and a random access memory (RAM), with each being coupled to the processor;
a selected one of the non-volatile memory and the RAM adapted to receive a downloaded authentication key generator to generate a key pair of a private key and a public key; and
a software program, stored in the non-volatile memory, adapted to seek access to a private computer network by providing a predefined identifier to an authentication server.

20. The system according to claim 19, further comprising:
a trusted security module (TSM) coupled to the bus and adapted to use the key pair for encryption and decryption within the TSM and adapted to encrypt at least the private key prior to the private key being stored in the non-volatile memory.

21. The system according to claim 20, wherein the TSM is further adapted to execute a trusted boot process to establish that at least the software program has not been modified.

22. The system according to claim 19, wherein
the software program is further adapted to send an access request to the authentication server and to receive a challenge from the authentication server to provide the predefined identifier, with the challenge being triggered by the access request; and
the software program is further adapted to provide the predefined identifier to the authentication server in response to the challenge from the authentication server.

23. The system according to claim 19, wherein
a trusted security module is adapted to decrypt within the trusted security module an encrypted challenge from the authentication device using the private key; and
the software program is further adapted to send the decrypted challenge to the authentication server to obtain the access to the private computer network.

24. The system according to claim 19, wherein the build predefined identifier is a selected one of a Universal Unique Identifier (UUID), an international mobile equipment identifier (IMEI), an equipment serial number (ESN), and a number implanted in the client device during manufacture of the client device.

25. An article comprising a machine-readable medium that contains instructions for an authentication server, which when executed by the authentication server, causes the authentication server to perform operations comprising:
in response to an access-seeking client device seeking access to a private computer network, receiving with the authentication server a requested predefined identifier from the access-seeking client device; and
using the requested predefined identifier to search a database for a matched device record, with the database having at least one device record of an associated pair of parameters received from at least one client device during a provisioning of the at least one client device and the associated pair of parameters including a build predefined identifier unique to the at least client device and a public key generated by the at least one client device.

26. The article according to claim 25, wherein the using of the requested predefined identifier to search at least the one device record in the database for the matched device record includes comparing the requested predefined identifier with at least the build predefined identifier of the at least one device record.

27. The article according to claim 26, wherein the operations further comprise:
if the matched device record is found, authenticating with the authentication server the access-seeking client device using the public key of the matched device record; and
if the matched device record is not found, denying access with the authentication server to the access-seeking client device.

28. The article according to claim 27, wherein the authenticating with the authentication server of the access-seeking client device includes:
presenting by the authentication server of an encrypted challenge to the access-seeking client device, with the encrypted challenge being a challenge encrypted by the public key;
receiving by the authentication server of a decrypted response from the access-seeking client device in response the encrypted challenge, with the decrypted response being the encrypted challenge decrypted by the access-requesting client using a private key associated with the public key; and
comparing by the authentication server of the decrypted response and the challenge, with a match being a prerequisite to granting the access request.

29. The article according to claim 28, further comprising:
validating with the authentication server that the client device has not been tampered.

30. The article according to claim 25, wherein the build predefined identifier is a selected one of a Universal Unique Identifier (UUID), an international mobile equipment identifier (IMEI), an equipment serial number (ESN), and a number implanted in the client device during manufacture of the client device.
